(19) United States
(12) Patent Application Publication
(10) Pub. No.: US 2008/0277917 A1
(43) Pub. Date: Nov. 13, 2008

(54) BOOKMARK

(76) Inventor: Antonio C. White, San Francisco, CA (US)

Correspondence Address: HAYNES BEFFEL & WOLFELD LLP, P O BOX 366, HALF MOON BAY, CA, 94019, US

(21) Appl. No.: 12/118,633

(22) Filed: May 9, 2008

Related U.S. Application Data
(60) Provisional application No. 60/917,596, filed on May 11, 2007.

(51) Int. Cl. B42D 9/00; B42D 15/00

(52) U.S. Cl. 281/42; 283/67

(57) ABSTRACT

A bookmark comprises a device sheet having first and second panels foldable between closed and open orientations. Each panel has an aligned weakened or cut region forming a clasp element manipulatable between a first orientation aligned with the panel and a second orientation extending from the panel. The clasp elements are aligned with one another when the panels are in the closed orientation and are simultaneously movable to the second orientation to create a multi-layer page clasp. Pages of a bound volume can be inserted between the page clasp and an outer surface of one of the first and second panels. A note sheet may be located between the inner surfaces when in the closed orientation. In some examples the note sheets comprise pre-printed matter.

### CROSS-REFERENCE TO OTHER APPLICATIONS

This application claims the benefit of provisional patent application No. 60/917,596 filed 11 May 2007 and entitled Bookmark.

### BACKGROUND OF THE INVENTION

Taking notes, such as when reviewing for tests for an academic class or preparing reports for a class or for a business purpose, is difficult or at least frustrating for many people. For example, one to three books may be reviewed for a report or test. Within these books the person will often make extensive notes by writing within the margins of the book, in addition to highlighting important words and sentences. Many times the person may also add Post-it® notes with additional information the person wants to remember along with other concepts which come to mind. The reference books often become a mess of underlining, highlighting and Post-it® notes. Transferring these notes and citations from multiple books, magazines and the like into a single document is one of the biggest chores when creating a report. Citations are important to give appropriate credit to those who have influenced the work product. Organizing all the various quotes, reports and other references can also be a daunting and time consuming task.

### BRIEF SUMMARY OF THE INVENTION

An example of a bookmark, for use with a bound volume comprising pages, comprises a device sheet having panels with clasp elements. The device sheet has a fold line dividing the device sheet into first and second panels foldable about the fold line between closed and open orientations. The panels have inner surfaces and outer surfaces. The inner surfaces face one another when in the closed orientation. Each panel has an aligned weakened or cut region forming a clasp element. Each clasp element is manipulatable between a first orientation aligned with the panel and a second orientation extending from the panel. The clasp elements are aligned with one another when the panels are in the closed orientation. The clasp elements are simultaneously movable to the second orientation when the panels are in the closed orientation to create a multi-layer page clasp. The multi-layer page clasp is configured to permit one or more pages of a bound volume to be inserted between the multi-layer page clasp and an outer surface of one of the first and second panels. In some examples a note sheet is located between the inner surfaces when in the closed orientation. In some examples the note sheets comprise pre-printed matter.

An example of a method for using a bookmark with a bound volume comprising pages is carried out as follows. A bookmark is selected. The bookmark comprises a device sheet having a fold line dividing the device sheet into first and second panels foldable about the fold line between closed and open orientations. The panels have inner surfaces and outer surfaces, the inner surfaces facing one another when in the closed orientation. Each panel has an aligned weakened or cut region forming a clasp element. Each clasp element is manipulatable between a first orientation aligned with the panel and a second orientation extending from the panel. The clasp elements are aligned with one another when the panels are in the closed orientation. The panels are placed in the closed orientation. The aligned clasp elements are simultaneously moved to the second orientation to create a multi-layer page clasp. The bookmark is placed adjacent to a selected page of a bound volume. One or more pages of the bound volume are inserted between the multi-layer page clasp and an outer surface of one of the first and second panels thereby marking the selected page. In some examples the bookmark selecting step comprises selecting a bookmark further comprising a note sheet located between the inner surfaces when in the closed orientation.

Other features, aspects and advantages of the present invention can be seen on review the figures, the detailed description, and the claims which follow.

### BRIEF DESCRIPTION OF THE DRAWINGS

FIG. 1 illustrates an example of a bookmark made according to the invention in an open orientation;

FIG. 2 shows two of the bookmarks of FIG. 1 in closed orientations;

FIG. 3 shows another example of a bookmark similar to that of FIG. 1;

FIG. 4 shows two of the bookmarks of FIG. 3 in closed orientations similar to that of FIG. 2;

FIGS. 5 and 6 each shows the bookmark of FIG. 4 with a page clasp in a second, outwardly extending orientation securing pages between the page clasp and an outer surface of the bookmark;

FIG. 7 shows the bookmark and book of FIG. 6 with the book closed;

FIG. 8 shows a further example of a bookmark removably secured to the binding portion of a magazine;

FIGS. 9-10 show a further example of a bookmark as a removable section of a main sheet to permit the bookmark to pass through a printer prior to being removed from the main sheet;

FIG. 11 illustrates a further example of the bookmark of FIG. 5 but including three sets of note sheets mounted to the inner surfaces of the first and second panels;

FIG. 12 shows a further example similar to FIG. 11 but including four sets of note sheets;

FIGS. 13-16 illustrate two further examples of the bookmark of FIGS. 1-4, each including a hideaway flap; and

FIGS. 17-25 show examples of specialized note sheets that can be used with the various examples of the bookmark.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments and examples are commonly referred to with like reference numerals.

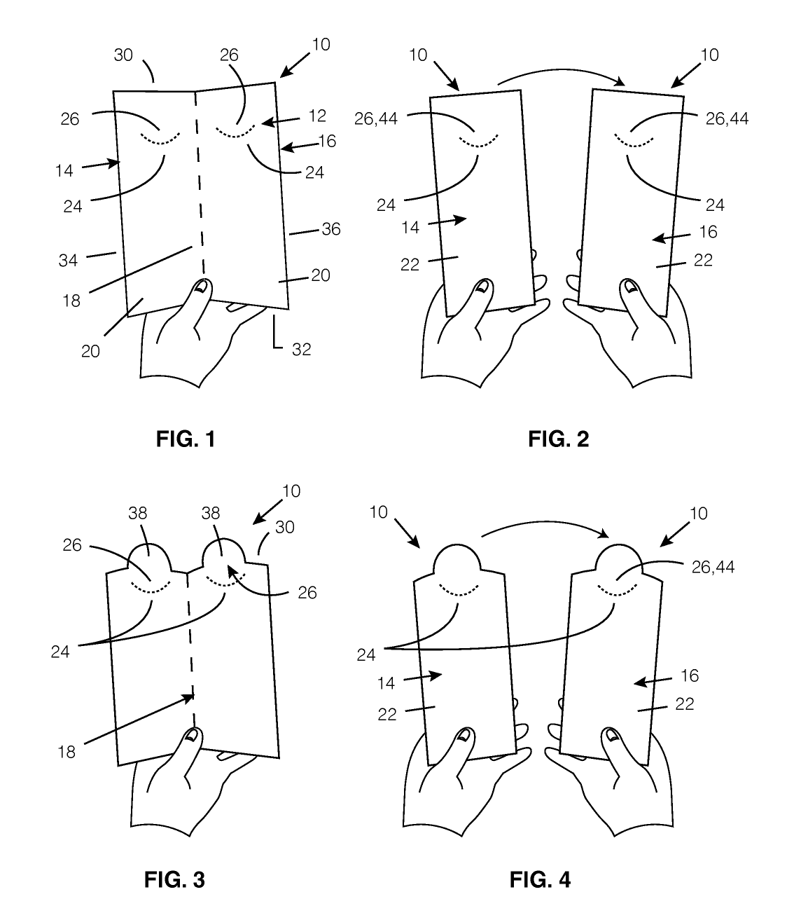

FIGS. 1 and 2 illustrate an example of a bookmark 10 made according to invention. FIG. 1 shows bookmark 10 in an open orientation while FIG. 2 shows two bookmarks 10 in closed orientations. Bookmark 10 includes a device sheet 12 including a first panel 14 and a second panel 16 joined at a central fold line 18. Each panel 16, 18 includes an inner surface 20, shown in FIG. 1, and an outer surface 22, shown in FIG. 2. Both first and second panels 14, 16 include a weakened/cut region 24, each region 24 forming a clasp element 26. Bookmark 10 also includes top and bottom edges 30, 32 extending from fold line 18 and side edges 34, 36 extending between top and bottom edges 30, 32 and, in this example, extending generally perpendicular to central fold line 18. Clasp element 26 can be manipulated between a first orientation aligned with its associated panel 14, 16, such as shown in FIGS. 1 and 2, and a second orientation extending from the panel; this second orientation will be discussed in more detail below.

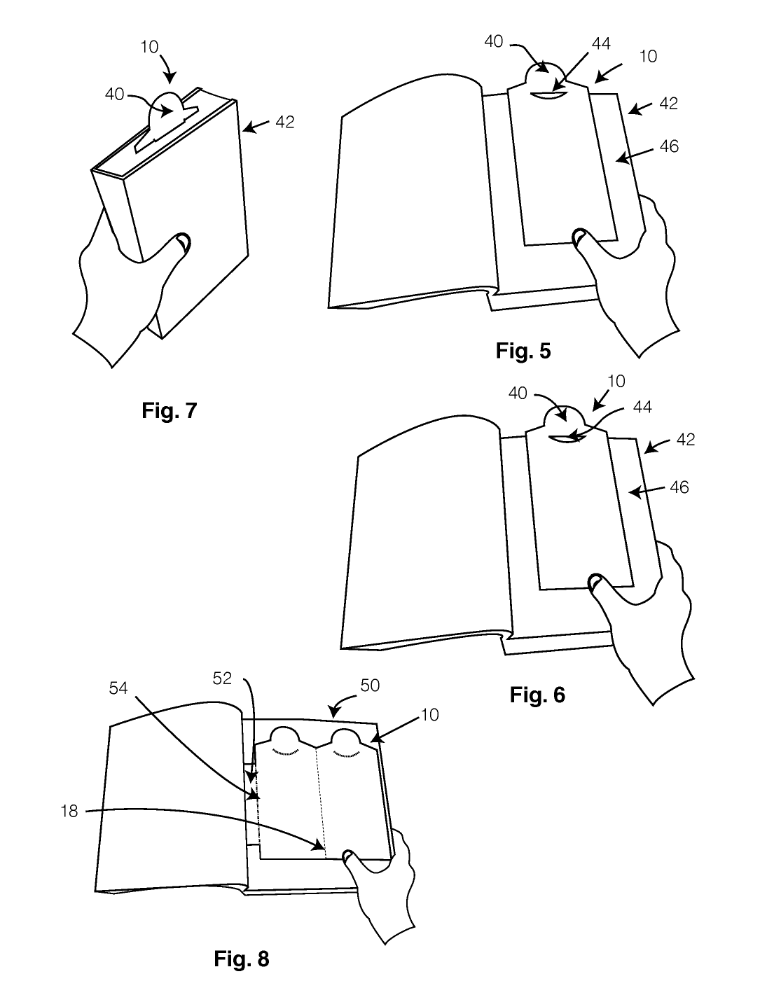

FIGS. 3 and 4 illustrate another version of bookmark 10 in which device sheet 12 includes panel extensions 38 along top edge 30. Panel extensions 38 provide exposed surfaces 40 when bookmark 10 is used with a book 42, as in FIGS. 5-7, or other bound volume such as a magazine, newspaper, newsletter or advertising brochure. For secure placement, bookmark 10 is placed in the closed orientation. In the closed orientation weakened/cut regions 24, and thus clasp elements 26, are aligned to create a multi-layer page clasp 44. The user manipulates page clasp 44 to move it from a first orientation aligned with panels 14, 16 to a second orientation extending from the panels. This permits one or more pages 46 of book 42 to be inserted between page clasp 44 and the outer surface 22 of the appropriate panel 14, 16.

One of the advantages of some examples of the invention is that a secure page clasp can be made by aligning two or more clasp elements 26 without the need for special reinforcement. Thus, bookmark 10 can be made of folded over paper stock and is still provide a clasp comparable in strength to more expensive metal or plastic bookmarks. Although in these examples two panels 14, 16 are used, three or more panels may also be used. Also, in these examples each panel 14, 16 is essentially the same size and shape, some or all of the panels may be different sizes or shapes, or both.

Another advantage of some examples of the invention is that exposed surfaces 40 can be used to customize the same basic bookmark 10 with artwork, messages, etc. by, for example, marking or printing or placing an appropriate sticker on exposed surfaces 40. This helps to reduce the cost of customized bookmarks. All or parts of inner and outer surfaces 20, 22 can also be enhanced, such as being printed on, decorated, colored or having stickers applied thereto.

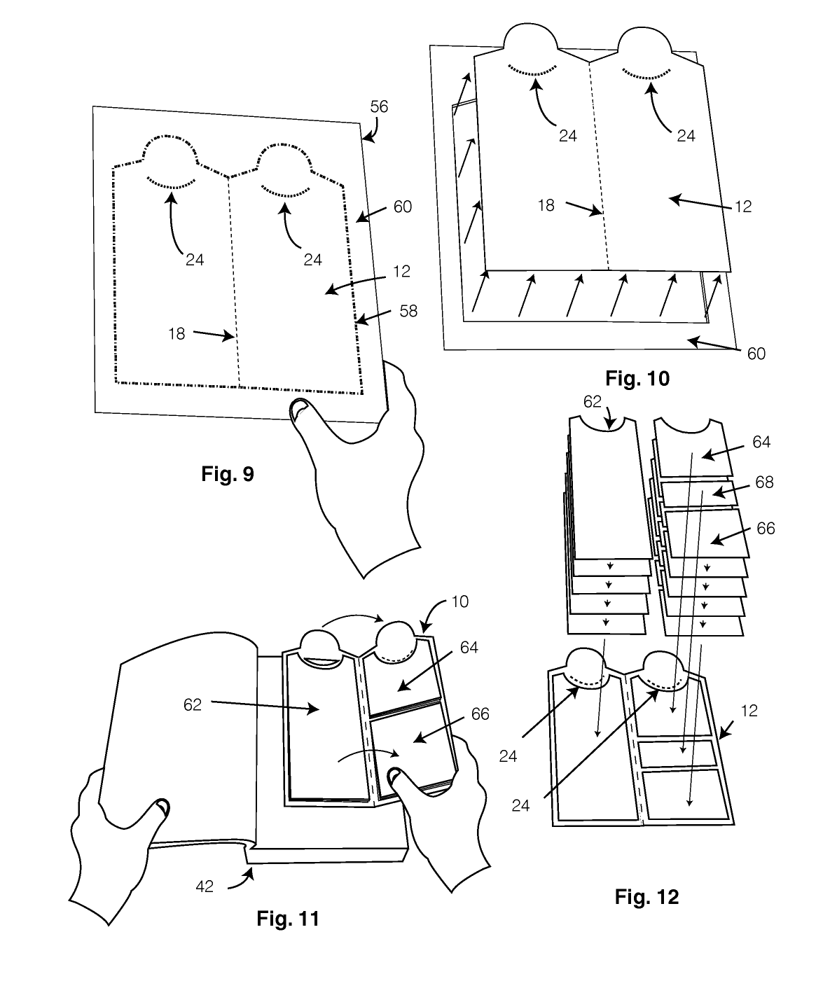

FIG. 8 illustrates a bookmark 10 distributed as a tear out bookmark within magazine 50. In this example a binding portion 52, secured to the binding of magazine 50, is coupled to bookmark 10 by perforations 54. Instead of using binding portion 52, bookmark 10 could be a free insert in magazine 50 or it could be attached to a page of the magazine using a releasable adhesive, such as rubber cement.

FIGS. 9 in 10 illustrate a different process for producing and distributing bookmarks 10. Typically a main sheet 56 is provided with device sheet 12 defined by perforations 58. A central fold line 18 is preferably provided. Main sheet 56 is then passed through a conventional printer to permit the user to apply any type of designs, information, instructions or advertising as desired. After printing on one or both sides, device sheet 12 can be removed from the remainder 60 of mainsheet 56 as illustrated in FIG. 10. Alternatively, a specialty cutting device can be used by a user to make perforations 58, or a complete cut, and weakened/cut region 24 using any type of appropriate stock.

Another aspect of the invention is the recognition that by making a folded bookmark 10, one or more note sheets can be carried, held or supported between the first and second panels 14, 16. FIG. 11 illustrates three sets of note sheets 62, 64, 66 mounted to inner surfaces 20 of first and second panels 14, 16. Bookmark 10 functions as a bookmark and also facilitates taking of notes, typically associated with reading of the book 42, magazine 50 or other bound volume with which it is used. FIG. 12 illustrates an alternative embodiment of the device of FIG. 11 including a fourth set of note sheets 68. Some or all of note sheets 62, 64, 66, 68 can be permanently or releasably secured within bookmark 10. Releasable note sheets can be, for example, Post-it® notes or other similar note sheets.

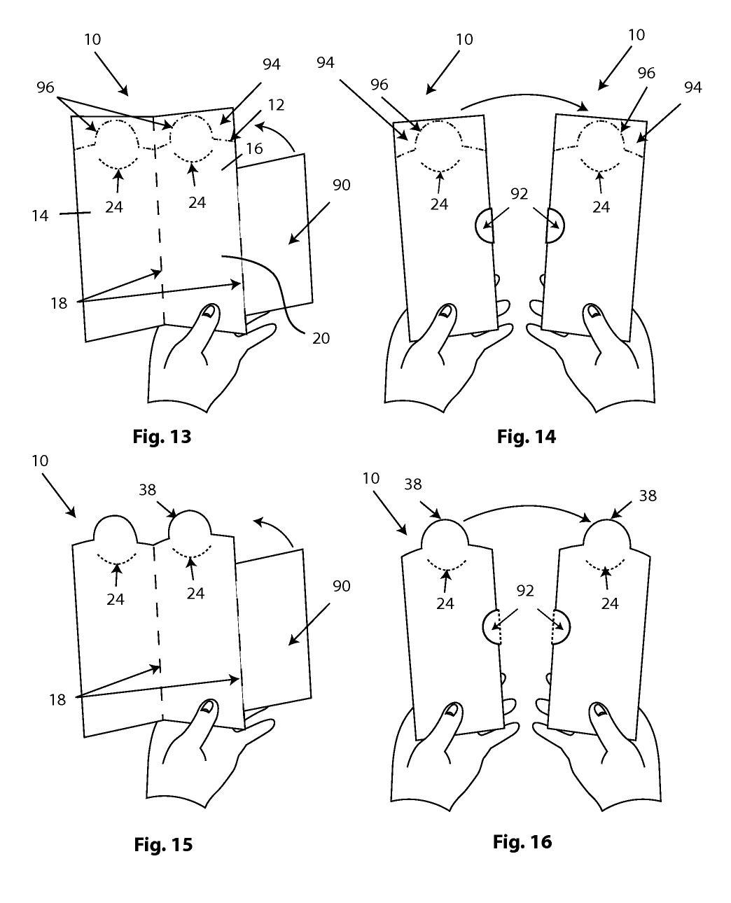

FIGS. 13-16 illustrate two further examples of bookmark 10. Each includes a hideaway flap 90 that can be folded over to lie against the inner surface 20 of second panel 16 prior to placing the bookmark in the closed orientations of FIGS. 14 and 16. In the closed orientation bookmark 10 and may be temporarily sealed shut using, for example, a sticker seal 92. Alternatively, other types of temporary closures, such as a releasable adhesive, could be used. In the closed, sealed configurations of FIGS. 14 and 16 bookmarks 10 are especially suited for mailing. The primary difference between example of FIGS. 13 and 14 versus the example of FIGS. 15 and 16 is that the FIGS. 13 and 14 example includes a removable top 94 of device sheet 12 that can be removed, typically by a user after received in the mail or retrieved from a magazine, along perforations 96.

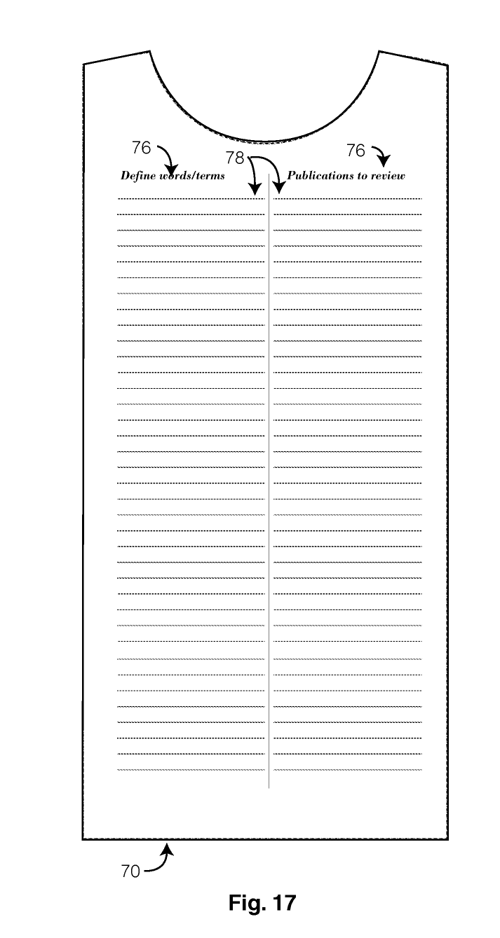

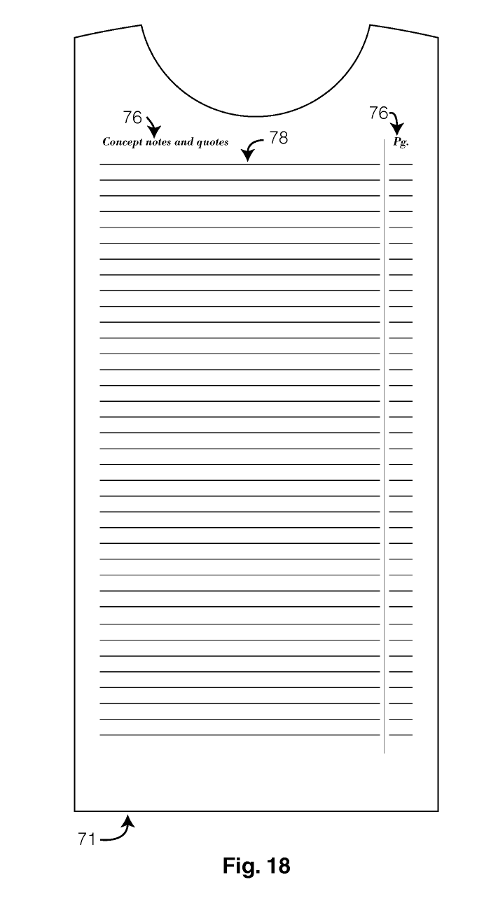

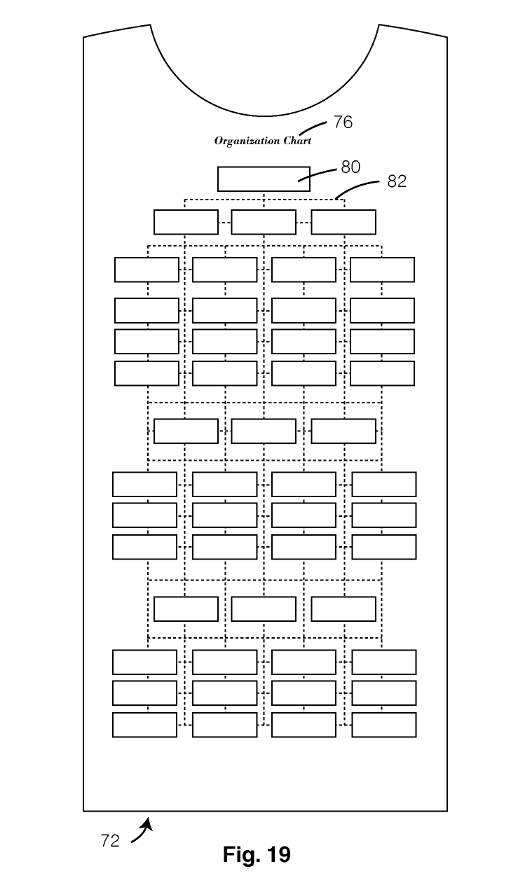

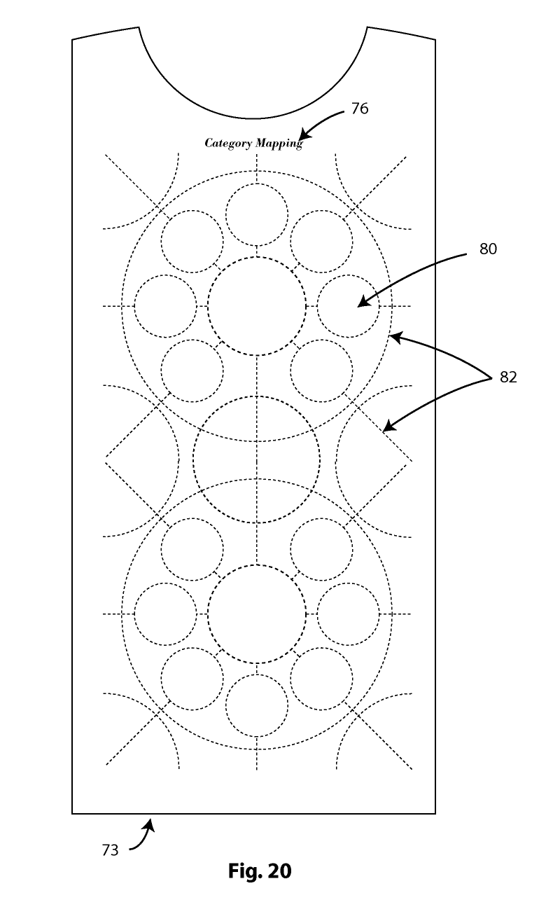

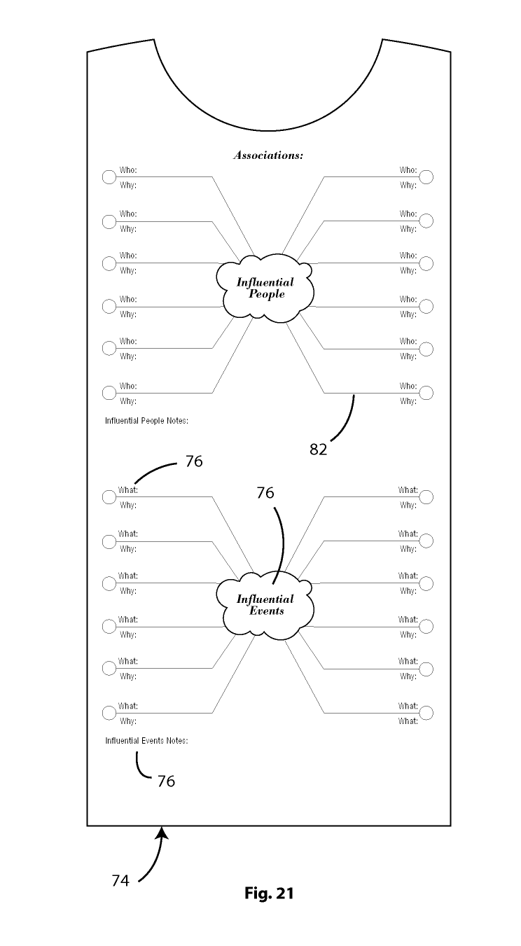

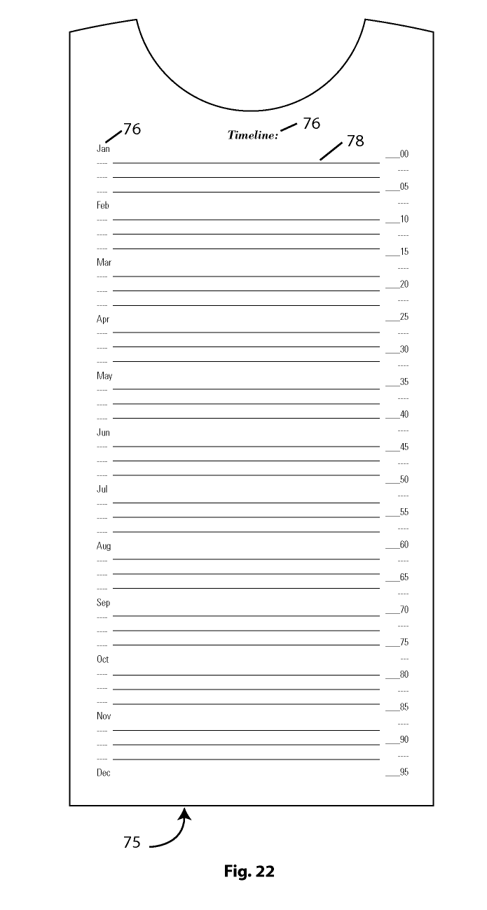

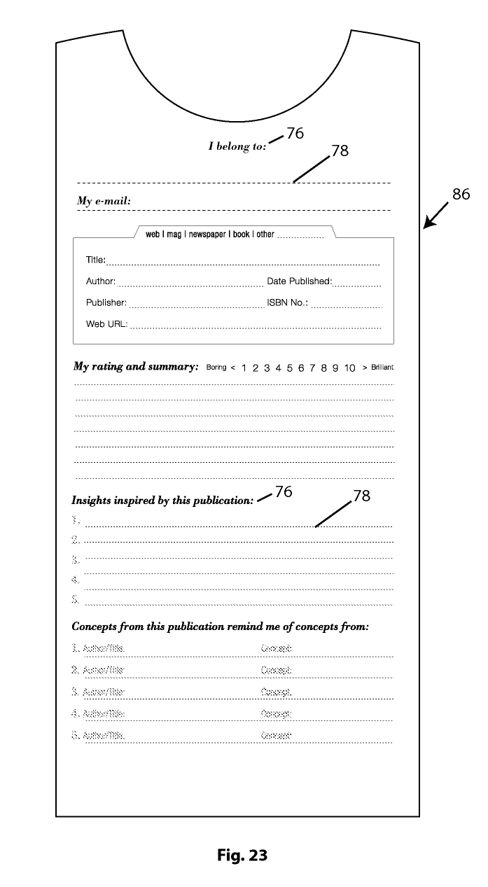

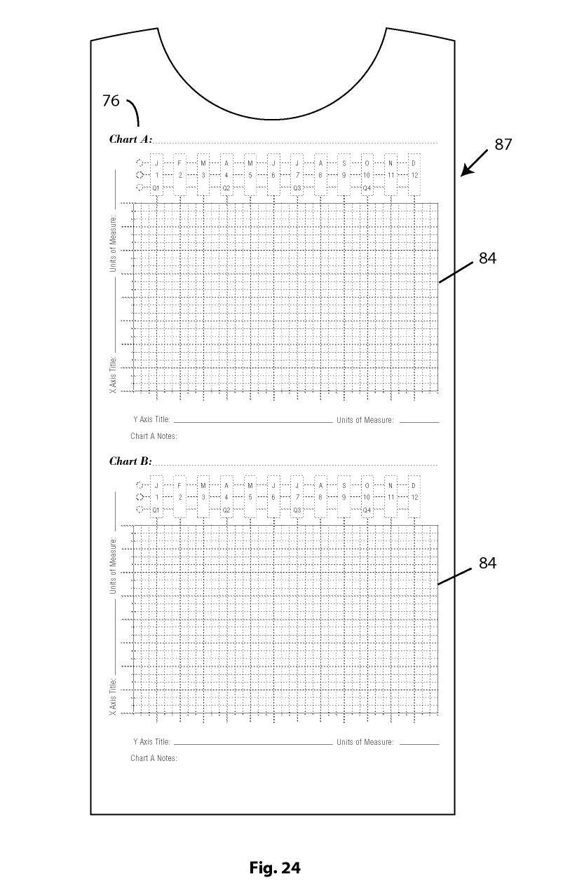

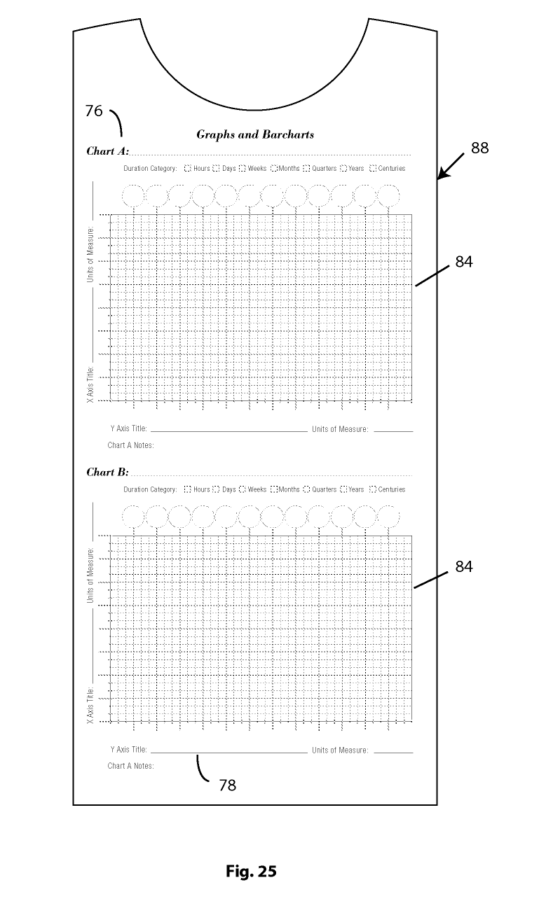

FIGS. 17-25 show examples of specialized note sheets 70-75 and 86-88 and that can be used with bookmark 10. These different note sheets 70-75 include various indicia, such as words 76, information entry lines 78, information regions 80, relationship lines 82 and chart areas 84, to help the user gather and organize information. Specialized note sheets can be provided with device sheet 12 or can be provided separately, or both.

Bookmark 10 can function as both an advertisement distributed with, for example, a magazine, and also as a bookmark. As such, bookmark 10 can (1) lengthen the effectiveness of the advertisement when the bookmark is removed and used, and (2) help reduce the amount of waste generated because of its continued use as a bookmark. A more effective advertisement may allow a magazine publisher to increase its advertising revenue.

Bookmark 10 can also be distributed in other ways, such as by directly mailing to potential customers. Based upon its usefulness as a bookmark, the advertising effectiveness of the direct-mail advertisement can be increased. Effectiveness of the advertisement is enhanced when the bookmark also includes plain or specialized note sheets because of the added value they create.

In addition, bookmarks 10 and note sheets designed for use with a particular book, or other bound volume, may be provided with that book. Replacement note sheets can then be sold separately. Also, bookmarks 10 and specialized note sheets can be sold together or separately at, for example, college bookstores to facilitate note taking in a variety of subjects.

In use, a bookmark 10 from, for example, a magazine 50 or sent through the mail, is typically folded about fold line 18 and placed in its closed orientation. The aligned clasp elements 26 are simultaneously pushed from one side to an orientation extending from one of the panels, such as panel 14, thus creating page clasp 44. Bookmark 10 is then placed adjacent to a selected page of the magazine or other bound volume and one or more pages 46 are inserted between page clasp 44 and the outer surface 22 of panel 14. When bookmark 10 has one or more note sheets, the user can access the note sheets and write on or otherwise use the note sheets.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, panels in addition to first and second panels 14, 16 may be used. In some examples the panels need not be the same size. Also, fold line 18 may not be in the center of device sheet 12 in some examples.

Any and all patents, patent applications and printed publications referred to above are incorporated by reference.

What is claimed is:

1. A bookmark, for use with a bound volume comprising pages, comprising:
a device sheet having a fold line dividing the device sheet into first and second panels foldable about the fold line between closed and open orientations;
the panels having inner surfaces and outer surfaces, the inner surfaces facing one another when in the closed orientation;
each panel having an aligned weakened or cut region forming a clasp element, the clasp element being manipulatable between a first orientation aligned with the panel and a second orientation extending from the panel;
the clasp elements being aligned with one another when the panels are in the closed orientation;
the clasp elements being simultaneously movable to the second orientation when the panels are in the closed orientation to create a multi-layer page clasp configured to permit one or more pages of a bound volume to be inserted between the multi-layer page clasp and an outer surface of one of the first and second panels.

2. The bookmark according to claim 1 further comprising a note sheet located between the inner surfaces when in the closed orientation.

3. The bookmark according to claim 1 further comprising multiple note sheets secured to the inner surface of at least one of the first and second panels.

4. The bookmark according to claim 1 wherein the note sheets comprise pre-printed matter.

5. The bookmark according to claim 4 wherein the preprinted matter comprises at least one of organizational chart indicia, category mapping indicia, timeline indicia, associations indicia, concepts and quotes indicia, and definitions indicia.

6. The bookmark according to claim 1 further comprising a bound volume binding portion extending from the first panel to permit the bookmark to be removably secured within a bound volume.

7. The bookmark according to claim 1 wherein the first and second panels have top and bottom edges extending from the fold line.

8. The bookmark according to claim 7 wherein the clasp elements are located closer to the top edge than to the bottom edge; and
whereby the panel extension is visible when the more pages are inserted between the multi-layer page clasp and the outer surface of one of the first and second panels.

9. A method for using a bookmark with a bound volume comprising pages, the method comprising:
selecting a bookmark comprising:
a device sheet having a fold line dividing the device sheet into first and second panels foldable about the fold line between closed and open orientations;
the panels having inner surfaces and outer surfaces, the inner surfaces facing one another when in the closed orientation;
each panel having an aligned weakened or cut region forming a clasp element, the clasp element being manipulatable between a first orientation aligned with the panel and a second orientation extending from the panel;
the clasp elements being aligned with one another when the panels are in the closed orientation;
placing the panels in the closed orientation;
simultaneously moving the aligned clasp elements to the second orientation to create a multi-layer page clasp;
placing the bookmark adjacent to a selected page of a bound volume; and
inserting one or more pages of the bound volume between the multi-layer page clasp and an outer surface of one of the first and second panels thereby marking the selected page.

10. The method according to claim 9 wherein the bookmark selecting step comprises selecting a bookmark further comprising a note sheet located between the inner surfaces when in the closed orientation.

11. The method according to claim 10 accessing the note sheet and marking on the note sheet.

12. The method according to claim 9 further comprising selecting a bound volume with the bookmark, and wherein the bookmark selecting step comprises removing the bookmark from the bound volume.

13. The method according to claim 12 wherein the bound body and has a binding, and the bookmark removing step comprises separating the bookmark from the binding.

14. The method according to claim 9 wherein the bookmark selecting step comprises removing the device sheet from a main sheet along a perforated edge separating the device sheet from a remainder of the main sheet.
